(19) United States
(12) Patent Application Publication
(10) Pub. No.: US 2023/0128024 A1
(43) Pub. Date: Apr. 27, 2023

(54) AUTOMATED VIRTUAL (AR/VR) EDUCATION CONTENT ADJUSTMENT BASED ON GAZE AND LEARNER ATTENTION TRACKING

(71) Applicant: KONINKLIJKE PHILIPS N.V., Eindhoven (NL)

(72) Inventors: Jia DU, EINDHOVEN (NL); Paul Anthony SHRUBSOLE, ARNHEM (NL); Yvonne KOKS, EINDHOVEN (NL)

(21) Appl. No.: 17/970,641

(22) Filed: Oct. 21, 2022

Related U.S. Application Data
(60) Provisional application No. 63/271,735, filed on Oct. 26, 2021.

(51) Int. Cl. G06T 19/20; G06F 3/16; G06F 3/01; G09B 5/14

(52) U.S. Cl. CPC G06T 19/20; G06F 3/165; G06F 3/013; G09B 5/14; G06T 2210/62; G06T 2219/2016; G06T 2219/2012

(57) ABSTRACT

A non-transitory computer readable medium stores instructions executable by at least one electronic processor to perform a virtual classroom method including: providing a three-dimensional (3D) virtual reality (VR) classroom including a presentation in the VR classroom; receiving, from one or more gaze tracking sensors, gaze data related to a gaze of at least one participant in the VR classroom; determining attentiveness of the at least one participant to the presentation in the VR classroom based on the received gaze data; and adjusting a rendering of the VR classroom based on the determined attentiveness.

### CROSS REFERENCE TO RELATED APPLICATIONS

This application claims the benefit of U.S. Provisional Patent Application No. 63/271,735 filed Oct. 26, 2021. This application is hereby incorporated by reference herein.

### FIELD

The following relates generally to the educational arts, augmented reality (AR) arts, virtual reality (VR) arts, gaze tracking arts, and related arts.

### BACKGROUND

Due to events, such as the COVID-19 pandemic, more and more activities that used to be done in a direct, face-to-face format are transferring to remote and virtual simulated context. These can be done in a simple audio/video call between two persons, or a videoconference session involving more people. This can also take place in a complete virtual reality (VR) environment. Each person is then represented with his or her unique virtual avatar, and communicate and interact in a virtual space. A VR meeting environment provided by Spatial Systems, Inc. (https://spatial.io/) is an example of this type of virtual workplace.

For educational classroom sessions, especially sessions where it is important for learners or participants to develop hands-on skills, presenting content in virtual simulated context is very helpful. Although not being in front of the actual device/object, the learners can get the feeling of being at the real device/object in a near-real environment. Furthermore, they can touch and interact with virtual objects to enhance the learning experience.

In a virtual classroom setting, especially when multiple learners are present in one virtual space, it is challenging for a teacher to keep track of how well each individual learner is paying attention (or not) to the presentation being provided by the teacher. In this kind of virtual environment, it is often not possible for the teacher to have direct eye contact with the participants (e.g., students) in the virtual classroom. The avatar of each participant's viewing direction and interaction may not represent the actual participant's behavior. The difficulty is thus to keep track of the attention of all students in the virtual space, and further facilitate focusing participants' attention on the presentation.

In situations where there are many learners (i.e., more than 10) present in a virtual teaching session, it can be very helpful to divide the group in sub teams to support the team in more focused discussion (this is often done in a normal workshop set up). However, in virtual teaching sessions, it is very difficult to do so due to limited interactions and lack of awareness of attention point of the learners.

The following discloses certain improvements to overcome these problems and others.

### SUMMARY

In one aspect, a non-transitory computer readable medium stores instructions executable by at least one electronic processor to perform a virtual classroom method including: providing a three-dimensional (3D) virtual reality (VR) classroom including a presentation in the VR classroom; receiving, from one or more gaze tracking sensors, gaze data related to a gaze of at least one participant in the VR classroom; determining attentiveness of the at least one participant to the presentation in the VR classroom based on the received gaze data; and adjusting a rendering of the VR classroom based on the determined attentiveness.

In another aspect, a non-transitory computer readable medium stores instructions executable by at least one electronic processor to perform a virtual classroom method including: providing a 3D VR classroom including a presentation in the VR classroom; receiving, from one or more gaze tracking sensors, gaze data related to a gaze of at least one participant in the VR classroom; determining attentiveness of the at least one participant to the presentation in the VR classroom based on the received gaze data; based on the received gaze data, determining a gaze of the at least one participant is directed away from the presentation towards a non-presentation element of the VR classroom; and adjusting a rendering of the VR classroom based on the determined attentiveness by de-emphasizing the non-presentation element.

In another aspect, a virtual classroom method includes: providing a 3D VR classroom including a presentation in the VR classroom; receiving, from one or more gaze tracking sensors, gaze data related to a gaze of at least one participant in the VR classroom; determining a quality of a plurality of segments of the presentation in the virtual classroom based on the received gaze data; and adjusting a rendering of the VR classroom between the segments based on the determined quality of each segment.

One advantage resides in providing for assessing the attention participants are paying to a virtual presentation in a virtual class room setting.

Another advantage resides in tracking the attention of participants in a virtual class room setting using gaze tracking.

Another advantage resides in modifying a virtual classroom setting to re-capture a participant's attention.

Another advantage resides in using sounds, color, or distancing to re-capture a participant's attention in a virtual classroom setting.

Another advantage resides in alternating a visual representation style of a presentation (e.g., opacity, brightness, and so forth) in a virtual classroom to capture attention of the participants in the virtual classroom.

A given embodiment may provide none, one, two, more, or all of the foregoing advantages, and/or may provide other advantages as will become apparent to one of ordinary skill in the art upon reading and understanding the present disclosure.

### BRIEF DESCRIPTION OF THE DRAWINGS

The disclosure may take form in various components and arrangements of components, and in various steps and arrangements of steps. The drawings are only for purposes of illustrating the preferred embodiments and are not to be construed as limiting the disclosure.

FIG. 1 diagrammatically illustrates an illustrative system for providing a virtual classroom in accordance with the present disclosure.

FIG. 2 shows exemplary flow chart operations of the system of FIG. 1.

FIG. 3 shows exemplary flow chart operations of another embodiment of the system of FIG. 1.

### DETAILED DESCRIPTION

The following relates to a virtual classroom employing a virtual reality (VR) or augmented reality (AR) system. Some examples of such systems include virtual spaces available from Spatial Virtual Spaces (https://spatial.io/), MeetinVR (Kobenhavn, Denmark), and workrooms available on Oculus® from Facebook Technologies, LLC. In such systems, each participant is represented by a three-dimensional (3D) avatar located in a 3D virtual meeting space. Typically, based on orientation sensors of the utilized AR/VR headset, the direction each participant is facing can be tracked, and thus simulated “face-to-face” conversations can be conducted or participants can look at something being presented by a presenter.

Disclosed herein are improvements in such 3D virtual meeting spaces. While participants can face each other, or a presentation, in the 3D virtual meeting space, existing systems do not provide for assessment of the actual level of attention participants are focusing on a particular presentation, or provide effective mechanisms for combating inattention.

While some 3D virtual meeting spaces track head motion using sensors in the headset, this provides only an approximate indication of the participant's focus. The following discloses employing gaze trackers to precisely track the gaze of each participant respective to the presentation to which the participants are expected to be attentive. The gaze trackers track the direction of the gaze (which may be different from the direction of the head since the eyes can look left-right-up-down while the head is stationary), and optionally may also track the depth of gaze (this is measurable by a gaze tracker based on the difference in left-versus-right eye rotation, where more difference in eye rotation corresponds to a closer depth of gaze).

The attentiveness of the participants to a presentation is assessed. If the participants are generally inattentive, then the presentation graphic, and/or a spatial audio effect may be adjusted to draw participants' attention to the presentation. For example, if the presentation is rendered using partial transparency, then the transparency factor can be reduced so as to make the presentation appear more solid, thus drawing attention to it. Other types of graphical highlighting may also be employed. Furthermore, if these techniques do not increase participants' attentiveness sufficiently, the form of the presentation could be changed. For example, if the presentation is initial a drawing board and this is not capturing the participants' attention, then it could be converted to a 3D rendering to be more attention-grabbing.

In some embodiments disclosed herein, if some other element in the 3D virtual meeting space is drawing participants' attention away from the presentation, then this other element can be made less conspicuous, e.g. by being made semi-transparent (or in an extreme case removed entirely) or by being moved further away from the participants.

Advantageously, participants' attention can be monitored in real-time and adjustments made in real-time, possibly also in coordination with the importance of the content. For example, if a part of the presentation is tagged as of critical importance, then the attention-grabbing modification of the presentation can be enhanced in those parts.

In other embodiments disclosed herein, aspects unique to a virtual 3D meeting space can be leveraged. For example, while videoconferencing systems commonly highlight a presenter (e.g. speaker) presenting the presentation using a highlighting box, in a virtual 3D meeting space the presenter can be highlighted by changing his or her size (e.g. making the presenter larger than everyone else) and/or by changing distance.

These various approaches for drawing participants' attention to a presentation can be utilized for participants as a whole, or on a per-participant basis. As an example of the former, the average or other aggregate attention of the participants as a group can be assessed, and the changes to the presentation and/or suppression of distractions can be done globally for all participants. As an example of the latter, the attentiveness of each individual participant can be individually assessed, and the changes to the presentation and/or suppression of distractions can be done individually for each participant. For example, if only one participant is being distracted by some other element in the 3D virtual meeting space, then that other element can be made semitransparent or removed entirely only for that one participant. In the case of adjustments of the rendering of the presentation, these also can be done individually and potentially differently for each participant, so as to render the presentation for each individual participant in a way that draws the attention of that participant.

Moreover, the attentiveness of the participants as a group and/or individually can be monitored and provided to the presenter of the presentation in real-time, for example in a window of the presenter's VR display, so that the presenter is made aware of the attentiveness of the group and/or of individual participants during the presentation. This allows for the presenter to adjust his or her presentation in real-time if the presentation is not attracting the attention of the participants. The group and/or individual attentiveness data can also be compiled and provided as feedback to the VR classroom organizer (e.g., a school, business, vendor, culture, background, or other entity putting on the VR class) after the VR class is completed so the organizer can assess how well the presentation was received. This can provide more objective feedback than, for example, conventional post-class evaluation forms whose answers can be subjective. This can then be used to select or design more attention-grabbing presentations in the future.

In some embodiments disclosed herein, the system could use similar tools to facilitate breaking a meeting into subgroups. The attentiveness of the participants in each sub-group to the presentation of that sub-group can be assessed and used to balance the attention-grabbing aspects of the respective presentations. For example, if one presentation is grabbing the attention of participants from other sub-groups then it could be scaled back in size and/or distinctiveness while the other presentations are enhanced.

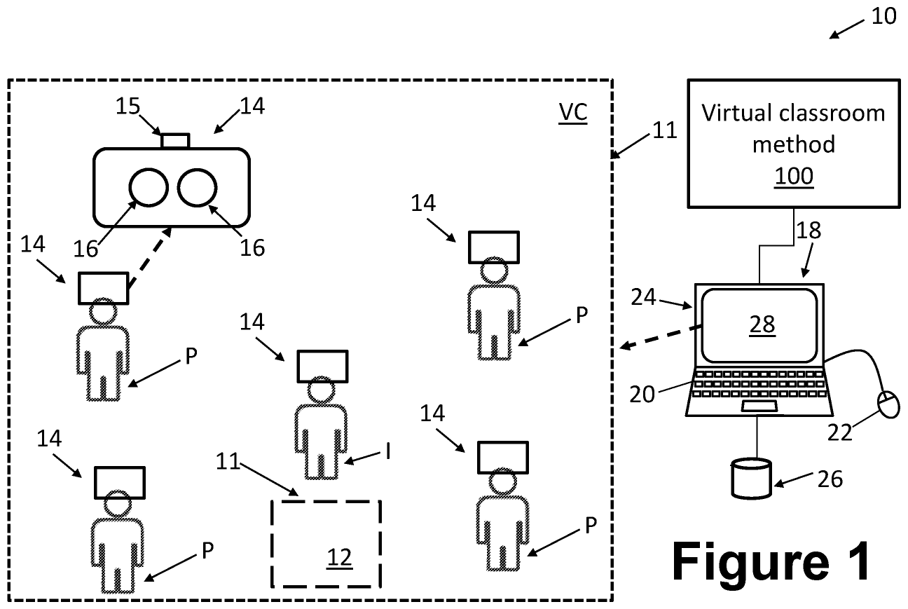

With reference to FIG. 1, an illustrative apparatus or system 10 for providing a rendering 11 of a three-dimensional (3D) virtual reality (VR) classroom VC is shown. It should be noted that the term “classroom” is to be broadly construed herein, and is not limited to an academic classroom setting. For example, the VR classroom VC could be an academic classroom, but could alternatively be a classroom provided by a corporation for the purpose of employee training, or could be a classroom provided by an equipment vendor for the purpose of training customers in the use of the equipment, or could be a classroom provided by a hospital or other medical facility for the purpose of providing health information to patients or other participants, and/or so forth. The VR classroom VC can serve as an AR/VR setting for a presentation 12 presented by an instructor I to one or more participants P. The rendering 11 of the VR classroom VC can include the presentation 12 (e.g., a presenter and/or a graphic), one or more participants P (four of which are shown in FIG. 1), and anything else required for the presentation 12. The VR classroom VR is an immersive VR environment, in which each participant's view changes as the participant moves his or her head, so as to simulate being in an actual 3D environment. To implement the immersive VR environment, the instructor (or “presenter”) I and each participant (e.g., student) P can wear a headset 14 (e.g., a VR or AR heads-up display (AR-HUD) having a camera 15 affixed thereto. The camera 15 can be used to project the rendering 11 of the VR classroom VC into a viewpoint of each participant P. In some examples, the headset 14 can be configured as a helmet, a headband, glasses, goggles, or other suitable embodiment in order to be worn on the head of the user. The headsets 14 worn by the participants P each include gaze tracking sensors 16 (also sometimes referred to in the art as eye trackers 16) configured to acquire gaze data related to a gaze of the participant(s) P in the rendering 11 of the VR classroom VC. In a typical implementation, the gaze tracking sensors 16 comprise cameras or other optical sensors built into the headset 14 that monitor the left and right eyeballs and determine the eyeball directions of the respective left and right eyeballs. Depth (or indeed location in 3D) of the participant's gaze can be determined as the crossing point of the left and right eyeball directions. The gaze sensors track the participant's eyeballs' directions and infer from that the direction of gaze. In some gaze tracking sensors 16, the difference between the directions is used to detect depth of gaze (i.e., the directions of gaze of the left/right eyeballs converge at some depth, which is the depth-of-gaze, and so forth). The actual display the eyes are looking at is only a few inches away from the eyeball of the participant P (i.e., it is the display mounted in the headset 14). If nothing is done, this creates severe eyestrain as the brain thinks it is looking at something in the scene that the brain perceives as being, for example, 15 feet away even though it is really only 3 inches away from the eyeball. The lenses are added into the headset 14 to create the illusion of distance, and those may be electronically adjustable focal length lenses.

By way of some nonlimiting illustrative embodiments, the headset 14 and computing system for providing the VR classroom VC (e.g., corresponding to an illustrative electronic processing device 18) can comprise an Oculus® system with Oculus® headsets, a HoloLens mixed reality (i.e., AR) system (available from Microsoft Corp., Redmond, Wash., USA), a Magic Leap VR system (available from Magic Leap, Inc., or so forth, or can be a custom-built VR system.

FIG. 1 also shows the electronic processing device 18, such as a workstation computer, a smartphone, a tablet, or so forth, configured to generate and present the VR classroom VC. Additionally or alternatively, the electronic processing device 18 can be embodied as a server computer or a plurality of server computers, e.g. interconnected to form a server cluster, cloud computing resource, various combinations thereof, or so forth. In other embodiments, the electronic processing device 18 can be integrated into the headset(s) 14. In further embodiments, the electronic processing device 18 can be connected to the headset(s) 14 via a wireless communication network (i.e., the Internet).

The electronic processing device 18 optionally includes typical components, such as an electronic processor 20 (e.g., a microprocessor), at least one user input device (e.g., a mouse, a keyboard, a trackball, and/or the like) 22, and at least one display device 24 (e.g. an LCD display, an OLED display, a touch-sensitive display, plasma display, cathode ray tube display, and/or so forth). In the VR context the conventional computer interfacing hardware 18 and 24 may optionally be omitted, as interfacing functionality may be provided by the headset 14 which constitutes an input device as accelerometers or other sensors in the headset 14 detect head movement which serves as input and a microphone detects voice input, and the display of the headset 14 can serve as the system display. The gaze tracking sensors 16 also serve as user input, and can be leveraged in various ways. For example, in some VR systems the user may select a button superimposed on the VR display by staring at that button. Additionally, as disclosed herein the gaze tracking sensors 16 serve as inputs indicating attention of the wearer. Moreover, VR-specific input devices may be provided such as gloves with sensors for detecting hand motions and optionally with touch sensors to detect when the gloved hand picks up an object, or so forth.

The electronic processor 20 is operatively connected with a one or more non-transitory storage media 26. The non-transitory storage media 26 may, by way of non-limiting illustrative example, include one or more of a magnetic disk, RAID, or other magnetic storage medium; a solid state drive, flash drive, electronically erasable read-only memory (EEROM) or other electronic memory; an optical disk or other optical storage; various combinations thereof; or so forth; and may be for example a network storage, an internal hard drive of the electronic processing device 18, various combinations thereof, or so forth. It is to be understood that any reference to a non-transitory medium or media 26 herein is to be broadly construed as encompassing a single medium or multiple media of the same or different types. Likewise, the electronic processor 20 may be embodied as a single electronic processor or as two or more electronic processors. The non-transitory storage media 26 stores instructions executable by the at least one electronic processor 20. The instructions include instructions to generate a graphical user interface (GUI) 28 for display on the display device 24.

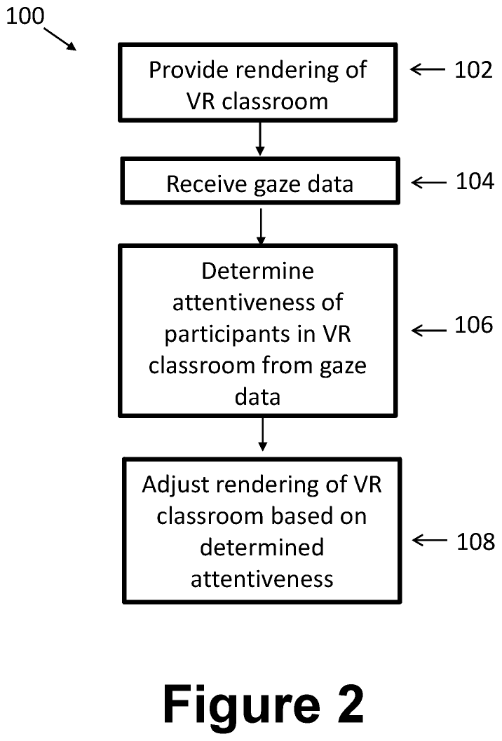

As disclosed herein, the non-transitory storage media 26 stores instructions that are readable and executable by the electronic processor 20 to perform a virtual classroom method or process 100. With reference to FIG. 2, and with continuing reference to FIG. 1, the electronic processing device 18 is configured as described above to perform the virtual classroom method 100. The non-transitory storage medium 26 stores instructions which are readable and executable by the electronic processing device 18 to perform disclosed operations including performing the method or process 100. In some examples, the method 100 may be performed at least in part by cloud processing.

At an operation 102, the rendering 11 of the 3D VR classroom VC is generated by the electronic processing device 18, and provided via the headset(s) 14 worn by the instructor I and each participant P. The rendering 11 of the 3D VR classroom VC includes the presentation 12.

At an operation 104, gaze data related to a gaze of at least one participant P in the VR classroom VC can be acquired by the gaze tracking sensors 16 of the headset 14 worn by the instructor I. The gaze data can be transmitted to the electronic processing device 18 for processing as described herein. In some examples, the gaze data comprises a direction of a gaze of one or more of the participants P, and the attentiveness of the participant(s) P is determined based on a fraction of time the gaze of the participant(s) P is directed to the presentation 12. In other examples, the gaze data comprises a depth of a gaze of the participant(s) P, and the attentiveness of the participant(s) P is determined based on a fraction of time the depth of gaze of the participant(s) P is at a depth of the presentation 12 from the participant(s) P.

At an operation 106, the electronic processing device 18 is configured to determine attentiveness of the participant(s) P to the presentation 12 in the VR classroom VC based on the received gaze data. From the determined attentiveness, at an operation 108, the rendering 11 of the VR classroom VC is adjusted to increase or “bring back” the attention of the participant(s) P. This can be performed in a variety of manners. In one example, the presentation 12 comprises a partially transparent graphic (e.g., a cube, or any other suitable shape), and the adjusting operation 108 includes reducing a transparency factor of the partially transparent graphic of the presentation 12. In another example, the presentation 12 comprises a graphic, and the adjusting operation 108 comprises highlighting the graphic. In another example, the presentation 12 comprises a two-dimensional (2D) graphic, and the adjusting operation 108 includes converting the 2D graphic of the presentation 12 to a 3D graphic. In yet another examples, the presentation 12 comprises a representation of a presenter of the presentation 12 (e.g., the instructor I while teaching the presentation, one of the participants P asking a question, and so forth). The adjusting operation 108 then comprises adjusting a size of the representation of the presenter. In another example when the presentation 12 comprises a representation of a presenter of the presentation 12, the adjusting operation 108 includes adjusting a distance between the representation of the presenter and a representation of at least one of the participants P in the VR classroom VC. In another example, the presentation 12 comprises an audio component, and the adjusting operation 108 includes adjusting the audio component of the presentation 12. This can include, for example, raising or lowering a volume of the audio component of the presentation 12, or adjust a spatial or directional setting of the audio component to guide the participant(s) P to move their gaze in a certain direction towards the presentation 12. These are merely examples and should not be construed as limiting.

In some embodiments, the attentiveness determination method 106 can include determining that a gaze of one or more of the participants P is directed away from the presentation 12 towards a non-presentation element of the VR classroom VC (e.g., away from the presenter, towards another participant P, at the “ground” or “outside” of the VR classroom VC, and so forth) based on the received gaze data (i.e., from the gaze data operation 104). The adjusting operation 108 then includes de-emphasizing the non-presentation element.

In other embodiments, the method 100 can further include determining whether a portion of the presentation 12 satisfies a predetermined importance criterion (e.g., an amount of participants P who are paying attention to that portion of the presentation 12, an amount of time that the participants P are paying attention to that portion of the presentation 12, and so forth). The portion of the presentation 12 that satisfies the predetermined importance criterion. This can help edit or “reduce” the amount of time of the presentation 12 if many of the participants P are not paying attention that to portion of the presentation 12 (i.e., based on the gaze data).

In some embodiments, the method 100 can further include determining a quality of a plurality of segments of the presentation 12 in the virtual classroom VC based on the received gaze data (e.g., again, based on whether the participants P are paying attention). The adjusting operation 108 then includes adjusting the rendering 11 between the segments based on the determined quality of each segment. The presentation 12 can then be updated based on the determined quality of each segment of the presentation 12.

In some embodiments, a plurality of participants P are present in the virtual classroom VC, and the attentiveness determination operation 106 includes determining the attentiveness of each participant P as an average attentiveness of the plurality of participants P. The adjustment operation 108 then includes adjusting the rendering 11 based on the determined average attentiveness and the adjusted rendering 11 is provided to all participants P. For example, if there are thirty participants P in the VR classroom VC, the average attentiveness of the thirty participants P can be measured, and the rendering 11 for all thirty participants P can be adjusted based on the average attentiveness.

In other embodiments when plurality of participants P are present in the virtual classroom VC, the attentiveness determination operation 106 includes determining the attentiveness of each participant P individually. The adjustment operation 108 then includes adjusting the rendering 11 individually for each participant P based on the determined attentiveness of that participant P, and the adjusted rendering 11 for that participant P is provided to that participant P. For example, if two participants P are determined to not be paying attention to the presentation 12, then the adjusted rendering 11 for one participant P can be to highlight a portion of the presentation 12, and the adjusted rendering 11 for another participant P can be to make transparent a portion of the presentation 12.

In some embodiments, an attentiveness of each participant P can be tracked over time using the gaze data to determine a rate of change in the attentiveness of each participant P throughout the duration of the presentation 12. By doing so, it can be determined whether the adjustments made to the presentation 12 responsive to the inattentiveness of the participants P can be useful in recapturing the attentiveness of the participants P. In one example, a type of adjustment can be determined that has optimal results for a given topic in the presentation 12 or for a given participant P. For example, it can be determined whether highlighting a portion of the presentation 12 works for one participant P (or topic), or whether adjusting a size of a portion of the presentation 12 works for another participant P (or another topic). These are merely examples. This attentiveness data can also be used in a predictive manner. For example, if an adjustment to the presentation 12 is needed, a look-ahead procedure can be performed to determine if the adjustment should occur immediately, or in a predetermined amount of time in the future. That is, if an adjustment is determined as needing to happen, but critical content in the presentation 12 is coming in, for example, the next 5-10 seconds, then the adjustment can be performed after that critical content (or a change in the view of the presentation 12, and so forth) is presented to the participants P. On the other hands, if that critical content (or the change in view, etc.). is not happening for another, for example, 30 seconds (or longer), and a most-recent adjustment was not made too recently, then the adjustment can be implemented immediately. In another variant, where it is determined that a change to increase attentiveness is called for, that change can optionally be implemented gradually, so as to not startle the participant P. For example, if the change is to increase the size of the instructor I then this could be done gradually over time, while monitoring the attentiveness of the participant P, and the increase of the instructor size can be stopped when the participant's attention is suitable drawn to the instructor I.

In some embodiments, learned-behavior of the participants P over multiple sessions of the presentation, or predicted behavior of the participants P, can be used to determine whether and/or when an adjustment to the presentation 12 should be made. For example, if the presentation 12 presents a point or topic in which typically makes (or is expected to make) several of the participants P ponder that point, it may be expected that a larger number of the participants P have gaze type responses that might appear to be inattentiveness as they purposefully break concentration to think about the point or topic. Such time points could be at set points in the presentation 12, or could be learned behavior from a data analysis of prior sessions. Hence, adjustments may not be made in such periods of apparent inattentiveness that are actually due to contemplation or deep thought. As another variant, such periods of contemplation or deep thought may be detected, and feedback given to the instructor I to create or extend a pause in the presentation 12.

In other embodiments, one or more feedback types (e.g., inputs, responses, motions, (e.g., hand motions, head nodding or shaking, and so forth)) of the participants P can be used to determine whether and adjustment should be made to the presentation 12.

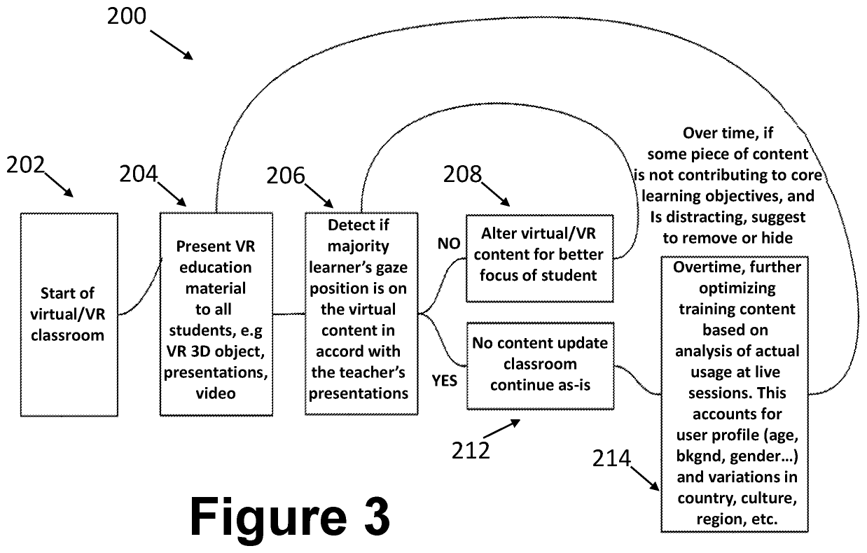

FIG. 3 shows another example of the method 200. At an operation 202, the VR classroom VC is provided. At an operation 204, the presentation 12 is provided on the headsets 14 of the participants P (and the instructor I). At an operation 206, the gaze of the participants' P is determined to determine the attentiveness of each participant P to the presentation 12. If the participant's P are determined to not be paying attention to the presenting 12 based on the gaze data, then, at an operation 208, the rendering 11 of the presentation 12 is adjusted to gain the attention of the participants P. If the participant's P are determined to be paying attention to the presenting 12 based on the gaze data, then, at an operation 210, the presentation 12 is continued. At an operation 214, the determined attention of the participants P, along with participant profiles, and variations in countries and language, can be used to update the presentation 12 for future uses.

The disclosure has been described with reference to the preferred embodiments. Modifications and alterations may occur to others upon reading and understanding the preceding detailed description. It is intended that the exemplary embodiment be construed as including all such modifications and alterations insofar as they come within the scope of the appended claims or the equivalents thereof.

1. A non-transitory computer readable medium storing instructions executable by at least one electronic processor to perform a virtual classroom method, the method comprising:
providing a three-dimensional (3D) virtual reality (VR) classroom including a presentation in the VR classroom;
receiving, from one or more gaze tracking sensors, gaze data related to a gaze of at least one participant in the VR classroom;
determining attentiveness of the at least one participant to the presentation in the VR classroom based on the received gaze data; and
adjusting a rendering of the VR classroom based on the determined attentiveness.

2. The non-transitory computer readable medium of claim 1, wherein the presentation comprises a partially transparent graphic, and the adjusting comprises:
reducing a transparency factor of the partially transparent graphic.

3. The non-transitory computer readable medium of claim 1, wherein the presentation comprises a graphic and the adjusting comprises:
highlighting the graphic.

4. The non-transitory computer readable medium of claim 1, wherein the presentation comprises a two-dimensional (2D) graphic, and adjusting comprises:
converting the 2D graphic to a three-dimensional (3D) graphic.

5. The non-transitory computer readable medium of claim 1, wherein the presentation comprises a representation of a presenter of the presentation, and adjusting the graphic comprises:
adjusting a size of the representation of the presenter.

6. The non-transitory computer readable medium of claim 1, wherein the presentation comprises a representation of a presenter of the presentation, and adjusting the graphic comprises:
adjusting a distance between the representation of the presenter and a representation of the at least one participant in the VR classroom.

7. The non-transitory computer readable medium of claim 1, wherein the presentation comprises an audio component, and adjusting the graphic comprises:
adjusting the audio component of the presentation.

8. The non-transitory computer readable medium of claim 1, wherein the method further includes:
based on the received gaze data, determining a gaze of the at least one participant is directed away from the presentation towards a non-presentation element of the VR classroom;
wherein the adjusting includes de-emphasizing the non-presentation element.

9. The non-transitory computer readable medium of claim 1, wherein the method further includes:
determining whether a portion of the presentation satisfies a predetermined importance criterion; and
tagging the portion of the presentation that satisfies the predetermined importance criterion.

10. The non-transitory computer readable medium of claim 1, wherein the method further includes:
determining a quality of a plurality of segments of the presentation in the virtual classroom based on the received gaze data; and
adjusting the rendering between the segments based on the determined quality of each segment.

11. The non-transitory computer readable medium of claim 10, wherein the method further includes:
updating the presentation based on the determined quality of each segment of the presentation.

12. The non-transitory computer readable medium of claim 1, wherein the gaze data comprises a direction of a gaze of the participant and the attentiveness of the at least one participant is determined based on a fraction of time the gaze of the at least one participant is directed to the presentation.

13. The non-transitory computer readable medium of claim 1, wherein the gaze data comprises a depth of a gaze of the at least one participant and the attentiveness of the at least one participant is determined based on a fraction of time the depth of gaze of the at least one participant is at a depth of the presentation from the at least one participant.

14. The non-transitory computer readable medium of claim 1, wherein:
the at least one participant comprises a plurality of participants;
the attentiveness of the at least one participant is determined as an average attentiveness of the plurality of participants; and
the adjusting of the rendering is based on the determined average attentiveness and the adjusted rendering is provided to all participants.

15. The non-transitory computer readable medium of claim 1, wherein:
the at least one participant comprises a plurality of participants;
the attentiveness of each participant is determined individually; and
the adjusting of the rendering is performed individually for each participant based on the determined attentiveness of that participant and the adjusted rendering for that participant is provided to that participant.

16. The non-transitory computer readable medium of claim 1, wherein determining attentiveness of the at least one participant to the presentation in the VR classroom based on the received gaze data includes:
tracking attentiveness of the at least one participant to the presentation over time to determine a rate of change in the attentiveness of each participant throughout the duration of the presentation.

17. The non-transitory computer readable medium of claim 1, wherein determining attentiveness of the at least one participant to the presentation in the VR classroom based on the received gaze data includes:
using attentiveness of the at least one participant to the presentation over time to determine whether an adjustment should be made to the presentation.

18. The non-transitory computer readable medium of claim 1, wherein determining attentiveness of the at least one participant to the presentation in the VR classroom based on the received gaze data includes:
using one or more feedback type provided by the at least one participant to determine whether an adjustment should be made to the presentation.

19. A non-transitory computer readable medium storing instructions executable by at least one electronic processor to perform a virtual classroom method, the method comprising:
providing a three-dimensional (3D) virtual reality (VR) classroom including a presentation in the VR classroom;
receiving, from one or more gaze tracking sensors, gaze data related to a gaze of at least one participant in the VR classroom;
determining attentiveness of the at least one participant to the presentation in the VR classroom based on the received gaze data;
based on the received gaze data, determining a gaze of the at least one participant is directed away from the presentation towards a non-presentation element of the VR classroom; and
adjusting a rendering of the VR classroom based on the determined attentiveness by de-emphasizing the non-presentation element.

20. The non-transitory computer readable medium of claim 19, wherein the presentation comprises a partially transparent graphic, and the adjusting comprises:
reducing a transparency factor of the partially transparent graphic.

21. The non-transitory computer readable medium of claim 19, wherein the presentation comprises a graphic and the adjusting comprises:
highlighting the graphic.

22. The non-transitory computer readable medium of claim 19, wherein the presentation comprises a two-dimensional (2D) graphic, and adjusting comprises:
converting the 2D graphic to a three-dimensional (3D) graphic.

23. A virtual classroom method, comprising:
providing a three-dimensional (3D) virtual reality (VR) classroom including a presentation in the VR classroom;
receiving, from one or more gaze tracking sensors, gaze data related to a gaze of at least one participant in the VR classroom;
determining a quality of a plurality of segments of the presentation in the virtual classroom based on the received gaze data; and
adjusting a rendering of the VR classroom between the segments based on the determined quality of each segment.
